(19) United States
(12) Patent Application Publication
(10) Pub. No.: US 2001/0030864 A1
(43) Pub. Date: Oct. 18, 2001

(54) Flashlight having illuminated accessories

(76) Inventors: Bruce W. Winkler, Madison, WI (US); John Sedovic, Middleton, WI (US); Robert J. Gold, Madison, WI (US)

Correspondence Address: Bennett J. Berson, Quarles & Brady LLP, 1 South Pinckney Street, P O Box 2113, Madison, WI, 53701-2113, US

(21) Appl. No.: 09/752,224

(22) Filed: Dec. 29, 2000

Related U.S. Application Data
(60) Provisional application No. 60/173,545, filed on Dec. 29, 1999.
(60) Provisional application No. 60/193,317, filed on Mar. 30, 2000.

(51) Int. Cl. F21L 4/00

(52) U.S. Cl. 362/208

(57) ABSTRACT

A flashlight using a single light source is provided having an accessory, such as a magnetic compass or a level, attached thereto. A light conduit communicates light from the light source to the accessory to provide adequate illumination during periods of low ambient light to allow a user to view the accessory. Accordingly, the flashlight uses a single light source that provides both the directed light beam for the flashlight, and the illumination of the accessory. The flashlight optionally includes an integral or attachable compartment for storing valuables or additional accessories.

### CROSS-REFERENCE TO RELATED APPLICATIONS

This application claims the benefit of the filing dates of provisional patent application Ser. No. 60/173,545, filed Dec. 29, 1999, and of provisional patent application Ser. No. 60/193,317, filed Mar. 30, 2000. The disclosure of each provisional patent application is incorporated by reference as if set forth in its entirety herein.

### STATEMENT REGARDING FEDERALLY SPONSORED RESEARCH OR DEVELOPMENT

Not applicable.

### BACKGROUND OF THE INVENTION

1. Field of the Invention.

The present invention relates to flashlights in general and, in particular, to a flashlight having illuminated accessories.

2. Description of Related Art.

Conventional flashlights are known to include a magnetic compass that is mounted thereto for the purposes of traveling in a desired direction, for example, when hiking or camping. These flashlights that include illumination means for the compass typically comprise a first light source that provides illumination for the flashlight beam, and a second separate light source that is configured to the compass. Both light sources are electrically connectable to a power source. Because the compass is backlit by a light source that is separate from the light source of the flashlight, the flashlight constructions require bulky and complex housing structures for the compass and the two light sources, thereby adding cost and complexity to the manufacturing, and resulting in undesirable design constraints. The illumination of two separate light sources creates an additional drain on the power supply, thereby shortening the life span of the batteries.

Other devices include a flashlight having a compass mounted thereon, but do not provide for the illumination of the compass, thereby rendering it essentially useless during periods of low ambient light, such as nightfall.

It is additionally well-known in the marketplace to combine a flashlight with a spirit level that allows a user to level, align, and install various components when, for example, performing construction related tasks in relatively small confines. Such conventional level flashlights have achieved little success in the marketplace and, as described above with reference to conventional compass flashlights, rely on a second light source to illuminate the level in addition to the light source of the flashlight, thereby resulting in the disadvantages described above.

It has therefore become desirable to provide a flashlight having illuminated accessories, such as at least one of a compass and spirit level, that is illuminated by a single, multi-function light source so as to provide observable information during periods of low ambient light.

### BRIEF SUMMARY OF THE INVENTION

The present inventor has recognized that a single light source may be used to operate a flashlight, and provide sufficient backlight for the illumination of a compass that is mounted onto the flashlight.

In accordance with one aspect of the invention, a flashlight has a housing that includes 1) a light emitting end having a light source disposed therein, and 2) a power source disposed therein that is configured to supply power to the light source. The flashlight further includes a light beam assembly that is in optical communication with the light source and configured to direct a light beam out the light emitting end. The housing supports an accessory, such as a compass or spirit level, and a light conduit is configured to communicate light from the light source to the accessory so as to illuminate the accessory when the light source is illuminated.

This and other aspects of the invention are not intended to define the scope of the invention for which purpose claims are provided. In the following description, reference is made to the accompanying drawings, which form a part hereof, and in which there is shown by way of illustration, and not limitation, a preferred embodiment of the invention. Such embodiment does not define the scope of the invention and reference must be made therefore to the claims for this purpose.

### BRIEF DESCRIPTION OF THE DRAWINGS

Reference is hereby made to the following figures in which like reference numerals correspond to like elements throughout, and in which:

FIG. 1 is a perspective view of a flashlight constructed in accordance with a preferred embodiment of the invention having a compass attached thereto;

FIG. 2 is a sectional side elevation view of the flashlight illustrated in FIG. 1;

FIG. 3 is a top elevation view of a compass flashlight constructed in accordance with an alternate embodiment of the invention;

FIG. 4 is a sectional front elevation view taken along line 4-4 of FIG. 3;

FIG. 5 is a sectional side elevation view of a beam emitting end of a flashlight constructed in accordance with an alternate embodiment;

FIG. 6 is a perspective view of a flashlight and an attachment with a compass formed therein, as constructed in accordance with an alternate embodiment of the invention;

FIG. 7 is a perspective view of a flashlight having an accessory attachment apparatus mounted thereto in accordance with another embodiment of the invention;

FIG. 8 is an enlarged perspective view of the attachment apparatus illustrated in FIG. 7;

FIG. 9 is a sectional side elevation view of the attachment apparatus illustrated in FIG. 7;

FIG. 10A is a perspective view of a flashlight bezel having a rotatable arm connected thereto in accordance with an alternate embodiment of the invention;

FIG. 10B is a perspective view of the flashlight bezel illustrated in FIG. 10A shown with the arm in a rotated position;

FIG. 11A is a perspective view of a flashlight bezel having an arm slidably attached thereto;

FIG. 11B is a perspective view of the flashlight bezel illustrated in FIG. 11A shown with the arm in an extended position;

FIG. 12 is a perspective view of a flashlight assembly including a flashlight and attachable compartment having an accessory attached thereto in accordance with an alternate embodiment of the invention; and

FIG. 13 is a perspective view of a flashlight having a spirit level mounted thereto in accordance with an alternate embodiment.

### DETAILED DESCRIPTION OF THE PREFERRED EMBODIMENT

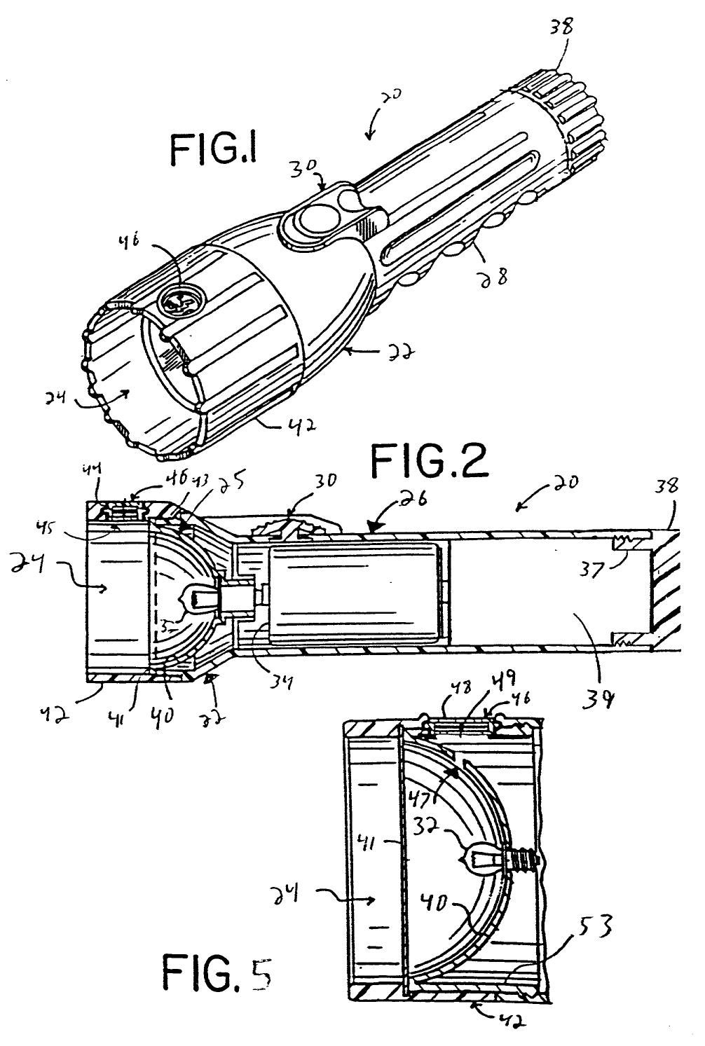

Referring initially to FIGS. 1 and 2, a flashlight 20 includes an elongated housing 22 that defines an open light beam emitting end 24 at one end, and a power source compartment 26 at the opposite end of the housing. The housing 22 may be formed from a plastic, rubber, or other suitable material, as is understood by those having ordinary skill in the art. The housing 22 includes a grip 28 on the outer surface thereof that is configured to accept the fingers of a human hand during operation. The flashlight further includes a light source 32 in the form of a bulb that is supported within the housing 22 in the conventional manner, and disposed proximal the light beam emitting end 24, and is powered by batteries 34 that are seated in the battery compartment 26. The light source becomes 32 illuminated in response to the activation of a power switch 30 which is configured to turn the flashlight on and off by depressing the switch.

The housing 22 includes a detachable butt 38 having a cylindrical inner flange 37 that is threadedly connected to the inner wall of the housing 22. The inner flange and housing may be made of rubber or plastic so as to form a watertight seal and to enclose an inner cavity 39 that is suitable for storing valuables or containing other devices, kits, tools and the like therewithin.

The flashlight 20 further includes a light beam assembly 25 that comprises a generally concave parabolic reflector 40 having an apex that is disposed axially upstream of the light source 32. The reflector 40 surrounds the light source and includes an annular outer flange 41 that is seated within the housing 22 and disposed downstream of the light source. It should be appreciated that the terms “upstream” and “downstream” are used to describe the position of various elements with reference to the direction of the light beam. The reflector 40 may be made from any plastic or other suitable material having reflective properties sufficient to receive light from the light source 32, and, in turn, produce a directed light beam out the light emitting end 24.

The flashlight 20 includes a bezel 42 that is threadedly connected to the housing 22 via threads 43 proximal to the light emitting end 24. The bezel 42 defines an aperture 44 that extends through the outer wall thereof, and that is configured to receive an accessory therein. In the illustrated embodiment, the accessory comprises a compass 46, such as a magnetic or digital compass, that is seated in the aperture 44 and secured therein via an adhesive, for example, at a position axially downstream of the reflector 40. The compass 46 includes an outer body portion 48 that forms the periphery of the compass, and is made of a translucent material such as a plastic that is capable of transmitting a sufficient amount of light to illuminate the compass, as will be described in more detail below. The compass 46 has an interior cavity that is filled with liquid, and further includes a compass rose that is rotatably disposed within the cavity, as is understood by those having ordinary skill in the art. The face of the compass is outwardly disposed so as to be visible to an operator of the flashlight.

A light conduit 45 is thereby formed that is configured to translate light produced by light source 32 to the compass. In the illustrated embodiment, the conduit 45 includes the compass body 48. The conduit 45 may further comprise the portion of the aperture 44 that is disposed radially inwardly of the compass body 48 if, for example, the compass body is recessed with respect to the inner surface of the wall. In this regard, it should be appreciated that the light conduit 45 could assume any configuration whatsoever that is capable of transmitting the light from the light source 32 to the compass 46.

Accordingly, when the light source 32 is illuminated, the light beam travels out the light emitting end 24 to provide the light beam, and also is transmitted to the compass 46 via light conduit 45, thereby sufficiently illuminating the compass so that the directional information provided thereon is observable to a user under low ambient light conditions. Advantageously, the flashlight 20 employs only the single light source 32 that provides both the directed light beam, and the illumination of the compass 46. As a result, the disadvantages associated with designing and manufacturing devices having separate light sources to provide the flashlight beam and to illuminate a compass are eliminated. While the compass 46 is illustrated as being flush with the outer surface of bezel 46, it should be appreciated that the compass could protrude outwardly therefrom, and be sealed using a suitable molding to prevent moisture from entering the flashlight.

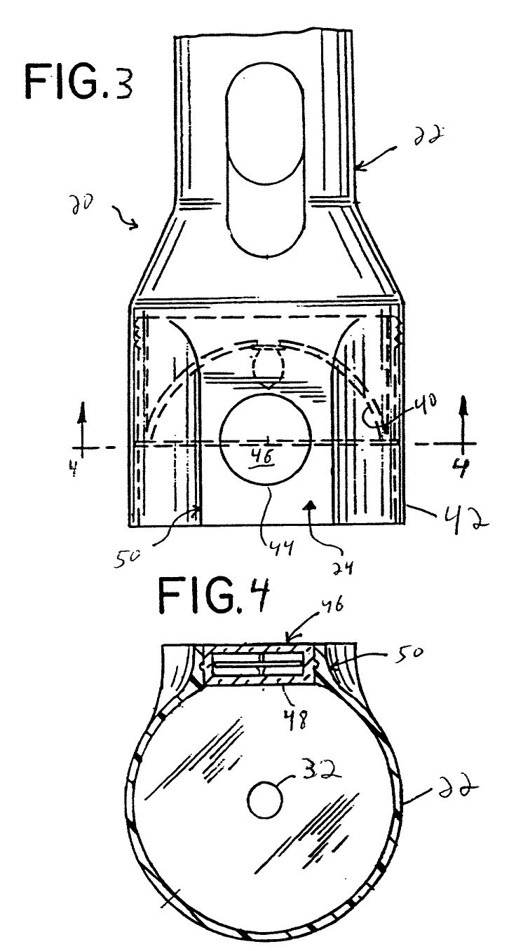

One disadvantage associated with the flashlight illustrated in FIG. 1 is the result of a portion of the bezel 42 that overhangs axially downstream of the outer flange 41 of reflector 40. During operation, some of the light beam is absorbed by the overhang, thereby decreasing the intensity of the light beam that travels out the light emitting end 24. This disadvantage is reduced in the alternate embodiment illustrated in FIGS. 3 and 4, in which the amount of bezel overhang is reduced. In particular, the bezel 42 includes a raised elongated channel 50 formed in the outer surface thereof. An aperture 44 is disposed in the channel 50, and, as described above, houses the magnetic compass 46 at a location whereby only a portion of compass 46 is disposed downstream of the flange 41 and in the path of light from the light source 32. The portion of the compass 46 that is disposed upstream of the flange 41 is shielded from the light by the reflector. However, even though the entire compass body 48 is not in optical communication with light source 32, the portion of the compass 46 that is in optical communication receives and conducts ample light to sufficiently illuminate the compass 46.

It should be appreciated that in this embodiment, because only a portion of the entire compass 46 is disposed downstream of the outer flange 41, the overhang necessary to house the compass is reduced. Accordingly, less light is absorbed by the bezel, and a stronger light beam is produced.

Referring now to FIG. 5, a compass flashlight is illustrated in accordance with an alternate embodiment that is configured to substantially eliminate light absorption by the bezel 42, thereby maximizing light beam intensity.

In particular, the magnetic compass 46 is seated in an aperture disposed in the bezel 42 in the manner described above. However, in this embodiment, the entire compass is located at a position axially upstream of the outer flange 41. An aperture 47 extends radially outwardly through the outer wall of the reflector 40 and forms a light conduit that allows light to travel from the light source 32 to the compass 46 when the flashlight is illuminated. When the bezel 42 is attached to housing 22, the aperture 47 is both substantially radially and axially aligned with the compass 46, which, as described above, extends at least partially through the outer wall of the bezel to receive light from light source 32.

The housing 22 may additionally include an internal flange 53 having threads 43 disposed on its outer wall that mates with inner threads of the bezel 42 when the flashlight is assembled. The flange 53 further supports the outer flange 41 of reflector 40, which is connected to the inner surface of the bezel 42. As a result, a portion of the flange 53 overlaps the compass 46 and aperture 47 in the radial direction. Accordingly, in order to allow the light to travel from the light source 32 through aperture 47 to the compass 46, an aperture 49 is formed in the outer wall of the flange 53, extending radially therethrough, and is axially aligned with aperture 47 and compass 46. The aperture 49 is sufficiently sized to allow a sufficient amount of light to travel to the compass 46, and has a circular cross section in accordance with the preferred embodiment. The threads 43 on the outer wall of the flange 53 and mating threads on the inner wall of the bezel 42 are aligned such that, when the bezel 42 is fully rotated onto the housing, the aperture 49 becomes radially aligned with the aperture 47 and compass 46. Accordingly, during operation, light from light source 32 travels through the apertures 47 and 49, and provides the necessary backlighting for the compass 46 to provide sufficient illumination to allow the user to view the compass during low ambient light conditions.

Because no overhang of the bezel 42 is required to house the compass 46 downstream of the outer flange 41, the flange 41 is located immediately adjacent the light emitting end 24 of the bezel 42. Therefore, substantially no light is absorbed by the bezel 42, and the light beam intensity of the flashlight is thereby maximized. The angle of the directed light beam is also increased as the result of the eliminated overhang.

Referring now to FIG. 6, a portable annular attachment 52 is illustrated that is at least temporarily connectable to the bezel 42 of a standard flashlight 54 proximal the light emitting end thereof. The attachment 52 includes an aperture 56 extending radially through the outer surface thereof and provides a seat for a compass 58, as described above. The attachment 52 may be friction fit onto the bezel 42 of the standard flashlight 54, or attached via any suitable alternative method such that at least a portion of the compass 58 is positioned downstream of the reflector and in optical communication with the light source, thereby ensuring that the compass will be sufficiently illuminated during operation of the flashlight. As a result, the attachment 52 allows a traditional flashlight to be temporarily transformed into a compass flashlight using a single light source that provides the necessary illumination for standard flashlight operation and that also sufficiently illuminates the compass so as to be observable during periods of low ambient visibility.

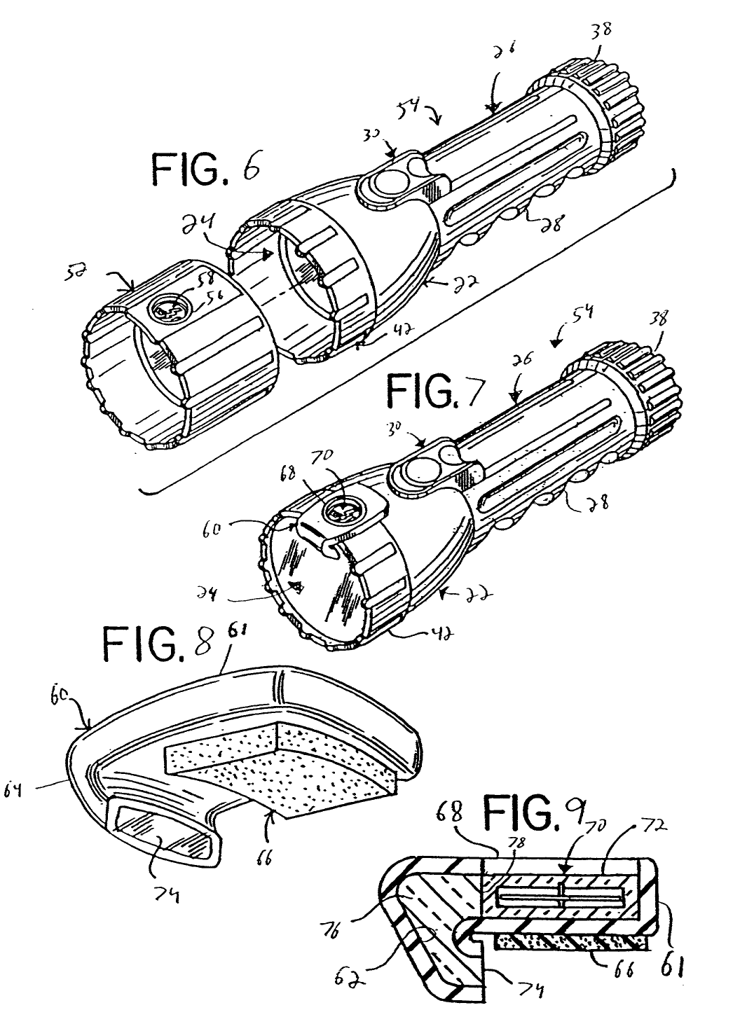

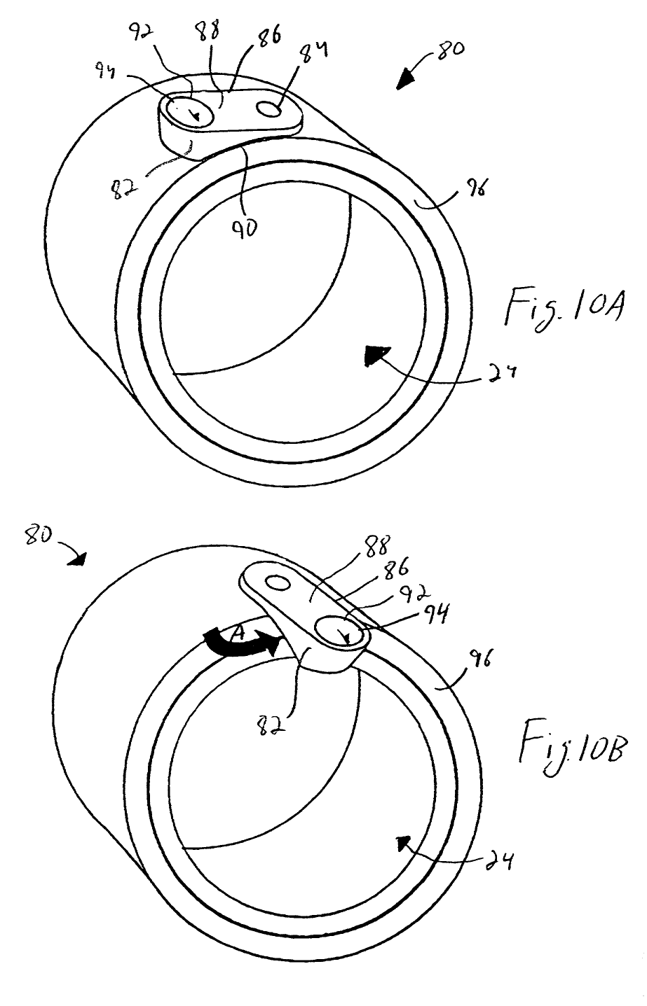

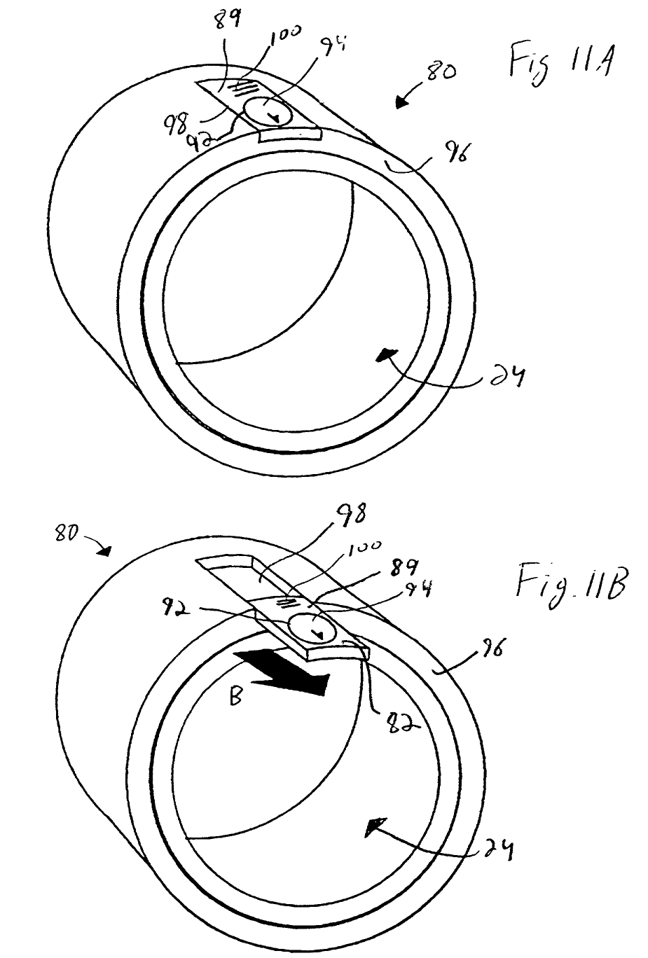

Referring now to FIGS. 7-9, a standard flashlight 54 may be modified using an attachment 60, as is illustrated in accordance with an alternate embodiment. In particular, a portable attachment 60 includes an axially extending upper body portion 61 that is integral with an outer lip portion 64 that is disposed axially downstream of upper body portion 61, and that curls radially inwardly with respect thereto. The attachment 60 may comprise a jacket made of a rubber or similar resilient material. An aperture 68 is formed in a radially outer surface of the upper body portion 61, and receives a compass 70 therein in the manner described above. An adhesive 66 is connected to the radially inner surface of the upper body portion 61, and is configured to temporarily affix the attachment 60 onto an outer surface of the bezel 42 of the pre-existing flashlight 54 proximal the light emitting end 24. In this configuration, the outer lip 64 curls around the end of the bezel and faces the light emitting end 24.

The lip portion 64 is hollow, thereby providing a channel 76 that extends from an inlet 74 to an outlet 78 that is disposed adjacent the upper body portion 61. The inlet 74 comprises the opening of the channel 76 that faces the light emitting end 24, and that receives light from the light beam. The compass 70 has a translucent body that is disposed in the upper body portion 61 adjacent, and upstream of, the outlet 78. Because the inner wall 62 of the lip attachment 64 is reflective, light from the light beam travels into the inlet 74, through the channel 76, and escapes at the outlet 78 where the light illuminates the compass 70. Accordingly, attachment 60 allows a flashlight to be temporarily modified to illuminate an accessory using only the single light source of the flashlight for illumination.

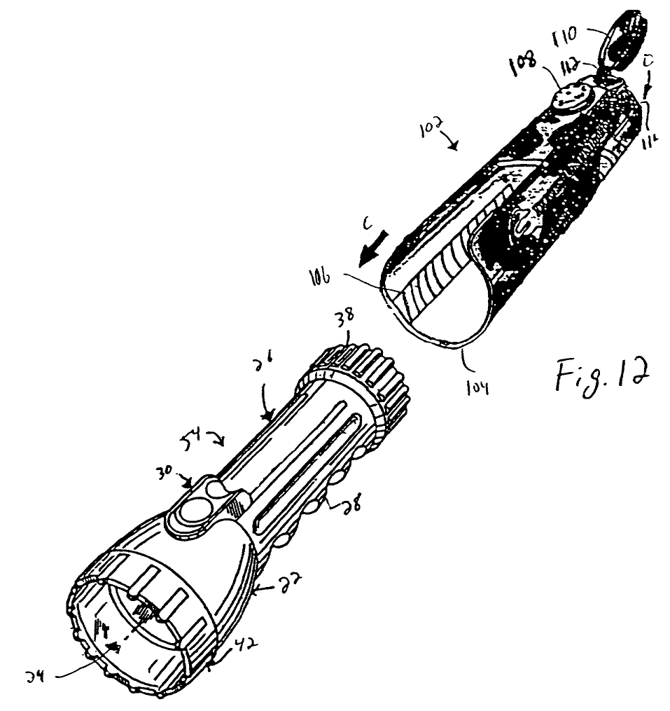

Referring now to FIGS. 10A and 10B, a bezel 80 is illustrated in accordance with an alternate embodiment, and may either comprise a preexisting bezel of a flashlight or an attachment that is connectable to a preexisting bezel. A pivot arm 86 is mounted onto the outer periphery of the bezel 80 via a pivot pin 84 so as to rotatably secure the pivot arm thereto. The pivot pin 84 is disposed proximal the light emitting end 24 of the bezel 80 such that, when the pivot arm 86 is rotated approximately 90° from a retracted position to an extended position, an outer end 82 of the arm is disposed downstream of the light emitting end 24.

The pivot arm 86 includes a generally flat upper surface 88, and an inner surface 90 having a contour that mates with the outer annular contour of bezel 80 so as to lay flush against the bezel when in the retracted position to reduce the risk of breakage during use. Upper surface 88 further includes an aperture 92 formed at the outer end 82 and provides a seat for a translucent compass 94 in the manner described above.

When in the retracted position, the bezel 80 shields the compass 94 from the light beam. To illuminate the compass 94, the arm 86 is rotated about pivot pin 84 in the direction of arrow A by approximately 90° to position the compass 94 axially downstream of the outer bezel wall 96, and thereby in optical communication with the light source 32. As a result, light from the single light source 32 travels out the light emitting end, and a sufficient amount of light travels radially outwardly at a sufficient angle so as to illuminate the compass 94. The arm 86 may be rotated once again by approximately 90° to retract the compass. Because the contour of inner surface 90 mates with the contour of collar 82, the arm 86 will lock into place when fully retracted.

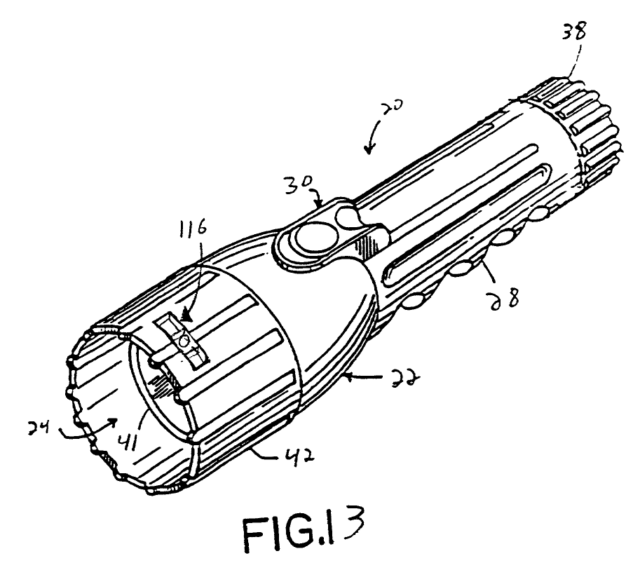

Referring now to FIGS. 11A and 11B, the bezel 80, constructed in accordance with yet another alternate embodiment of the invention, includes an elongated groove 98 extending axially in the outer surface thereof proximal the light emitting end 24. A compass arm 89 is disposed within the groove 98, and is slidable therein in the direction of arrow B from a retracted position, shown in FIG. 11A, to an extended position, shown in FIG. 11B. The magnetic compass 94 is seated in aperture 92 at the outer end 82 of the compass arm 89 as described above. The arm 89 further includes perforations 100 on its radially outer surface that are configured to accept an operator's finger to easily slide the arm back and forth.

When in the retracted position, the bezel 80 shields the compass 94 from the light beam. However, when the arm 89 is extended, the compass 94 is positioned axially downstream of the outer bezel wall 96. Accordingly, when the flashlight is on, and the arm is extended, the compass 94 will receive sufficient light from the light beam so as to provide observable information during periods of low ambient light. Accordingly, the bezel 80 allows the compass 94 to be backlit using the same single light source that is used to provide the light beam during operation of the flashlight.

Referring now to FIG. 12, a flashlight attachment 102 includes an annular body 104 having a plurality of notches 106 extending axially on an inner surface thereof that are configured to be mounted co-axially onto the housing 26 of the preexisting flashlight 54. In particular, the attachment 102 is translated axially in the direction of arrow C over the rear of the housing, so as to allow notches 106 to interact with mating notches on the flashlight 54 (not shown). The attachment 102 may also comprise a release mechanism, as is well known in the art, to allow for the temporary modification of the preexisting flashlight 54. The attachment 102 further includes a compass 108 that is mounted on an outer surface thereof so as to be visible by the user. The attachment further includes a door 110 that is hingedly connected to the rear 114 of the attachment via hinges 112. When the door 110 is open, and internal cavity (not shown) is accessible that is configured to accept belongings such as money, jewelry and the like. The internal cavity can contain other devices, kits, tools. The door 110 locks into place by rotating it in the direction of arrow D, thereby forming a watertight seal between the door and the rear 114 of attachment 102. It should further be appreciated that the attachment 102 may alternatively form an integral part of the flashlight 54, as is understood by one having ordinary skill in the art.

Referring now to FIG. 13, the flashlight 20 described above with reference to FIGS. 1 and 2 may include a spirit level 116 mounted thereon in a similar manner as compass 26. The level 116 is an assembly that includes an outer body portion of translucent material, such as a plastic or the like, and which has an interior cavity containing a liquid. While the level 116 is described as a spirit level in accordance with the preferred embodiment, it should be appreciated that may be configured as a bar level, a circular level, or any alternative level as understood by those having ordinary skill in the art. A radially extending elongated groove 118 is disposed in the outer surface of bezel 42, thereby providing a seat for the level 116, which may be fastened therein using a standard adhesive or other suitable mounting apparatus. The level 116 may extend entirely or partially through an aperture extending radially through the wall of the bezel 42, thereby providing an adequate conduit to allow light from the light beam to illuminate the level. Accordingly, only a single light source is used to provide illumination for both the flashlight beam as well as the level 116.

In the illustrated embodiment, the entire level 116 is disposed axially downstream of the outer flange 41 of the reflector. Accordingly, in order to support the level 116, the bezel 42 overhangs axially downstream of the reflector, thereby decreasing the amount of light that is allowed to exit the light beam emitting end 24, as described above.

In accordance with an alternate embodiment, only a portion of the level 116 is positioned axially downstream of the flange 41, such as at the axial location of compass 46 described above with reference to FIGS. 3 and 4. In this embodiment, the amount of bezel 42 overhang is reduced, and the level receives 116 ample light from the light beam to provide suitable illumination thereof, and to thereby permit a user to observe the level during periods of low ambient lighting.

The level 116 may alternatively be mounted onto the bezel 42 at the axial location of the compass 46 illustrated in FIG. 5 so as to essentially eliminate the overhang and maximize the light beam intensity. In fact, the level may assume any configuration whatsoever as described above with reference to the compass flashlight embodiments illustrated in FIGS. 1-12.

Accordingly, the level may be seated in an elongated radially extending aperture in the annular attachment 52 described above with reference to FIG. 6. Alternatively, the level may be seated in an elongated radially extending groove disposed in the outer surface of upper body portion 61 of attachment 60 described above with reference to FIGS. 79. Alternatively still, the level 116 may be attached to the rotatable arm 86 described above with reference to FIGS. 10A and 10B, or to the slidable arm 89 described above with reference to FIGS. 11A and 11B. In a further alternate embodiment, the level 116 may be disposed on the outer surface of the flashlight attachment 112 as described above with reference to FIG. 12. It should be appreciated that, in all of the above embodiments, the single light source 32 of the flashlight provides sufficient illumination for the level 116.

While the embodiments above describe the level 116 as being radially orientated, it should be appreciated that the level may extend axially, or in any alternative orientation, if so desired. The level 116 (or any accessory, for that matter) can be mounted in a rotatable housing such that it can be oriented as desired by rotating the housing.

It should further be appreciated that the embodiments described above with reference to FIGS. 1-13 are not limited to either a level or a compass, and that the two accessories could be implemented in combination. Moreover, the compass could be implemented in accordance with one of the embodiments, while the level is implemented in accordance with a different embodiment so long as the two embodiments are compatible. In all of these embodiments, a single light source would be used to provide a suitable light beam during operation of the flashlight, and would further provide sufficient illumination for the compass and the level so as to allow observation thereof during periods of low ambient light.

The above has been described as a preferred embodiment of the present invention. It will occur to those that practice the art that many modifications may be made without departing from the spirit and scope of the invention. Accordingly, in order to apprize the public of the various embodiments that may fall within the scope of the invention, the following claims are made.

I claim:

1. A flashlight comprising:
a housing including
1) a light emitting end having a light source disposed therein; and
2) a power source disposed therein configured to supply power to the light source;
a light beam assembly in optical communication with the light source and configured to direct a light beam out the light emitting end;
an accessory supported by the housing; and
a light conduit configured to communicate light from the light source to the accessory so as to illuminate the accessory when the light source is illuminated.

2. The flashlight as recited in claim 1, wherein the light emitting end further comprises a bezel that forms a portion of the housing, and wherein the light beam assembly further comprises a reflector disposed within the bezel that is configured to receive light from the light source and direct the light beam out the light emitting end.

3. The flashlight as recited in claim 2, wherein the entire accessory is supported by the bezel and disposed axially downstream of the reflector with respect to the light beam.

4. The flashlight as recited in claim 2, wherein a portion of the accessory is supported by the bezel and disposed axially downstream of the reflector with respect to the light beam.

5. The flashlight as recited in claim 2, wherein the entire accessory is disposed axially upstream of the reflector with respect to the light beam.

6. The flashlight as recited in claim 5, wherein the light conduit comprises an first aperture extending through the reflector that is substantially axially and radially aligned with the accessory.

7. The flashlight as recited in claim 6, wherein the housing further comprises an axially extending annular flange that is threadedly attached to the bezel and that overlaps the reflector in the radial direction, and wherein the light conduit further comprises a second aperture disposed in the annular flange that is substantially axially and radially aligned with the first aperture.

8. The flashlight as recited in claim 1, wherein the accessory comprises a translucent material.

9. The flashlight as recited in claim 1, wherein the accessory is mounted onto an arm that is attached to the bezel and that is movable from a retracted position to an extended position wherein at least a portion of the accessory is disposed axially downstream of the light emitting end with respect to the light beam.

10. The flashlight as recited in claim 9, wherein the arm is rotatable about a pivot location on the housing.

11. The flashlight as recited in claim 9, wherein the arm is disposed in an axially extending groove in the housing, and is slidable therealong.

12. The flashlight as recited in claim 1, wherein the accessory comprises a compass selected from the group consisting of a magnetic compass and a digital compass.

13. The flashlight as recited in claim 1, wherein the accessory comprises a level apparatus.

14. A flashlight attachment apparatus configured to be attached to a conventional flashlight having 1) a housing including (a) a light emitting end having a light source disposed therein and (b) a power source disposed therein that is configured to supply power to the light source, and 2) a light beam assembly in optical communication with the light source and configured to direct a light beam out the light emitting end, the attachment apparatus comprising:
a housing member defining a cavity having an upper surface, wherein an aperture extends through the upper surface;
an accessory disposed within the cavity and substantially aligned with the aperture; and
a channel member connected to the housing member and having a first terminal end configured to face the light emitting end and a second terminal end facing the accessory, wherein the second terminal end is in optical communication with the first terminal end via a light conduit that is configured to supply light from the light source to the accessory.

15. The attachment apparatus as recited in claim 14, wherein the light conduit further comprises a reflective inner wall of the channel member.

16. The attachment apparatus as recited in claim 14, wherein the housing member further comprises a second substantially axially extending surface disposed radially inwardly of the accessory, wherein the second axially extending surface is attachable to the housing of the conventional flashlight.

17. The attachment apparatus as recited in claim 14, wherein the accessory comprises a translucent material.

18. The attachment apparatus as recited in claim 14, wherein the accessory comprises a compass selected from the group consisting of a magnetic compass and a digital compass.

19. The attachment apparatus as recited in claim 14, wherein the accessory comprises a level apparatus.
